(19) United States
(12) Patent Application Publication
(10) Pub. No.: US 2022/0293937 A1
(43) Pub. Date: Sep. 15, 2022

(54) POSITIVE ELECTRODE AND NON-AQUEOUS ELECTROLYTE SECONDARY BATTERY INCLUDING THE POSITIVE ELECTRODE

(71) Applicant: Prime Planet Energy & Solutions, Inc., Tokyo (JP)

(72) Inventors: Masataka TOMITA, Okazaki-shi, Aichi-ken (JP); Hiroyuki YAMAGUCHI, Toyota-shi, Aichi-ken (JP)

(21) Appl. No.: 17/693,422

(22) Filed: Mar. 14, 2022

(30) Foreign Application Priority Data
Mar. 15, 2021 (JP) 2021-041418

(51) Int. Cl. H01M 4/525; H01M 4/505; H01M 4/58

(52) U.S. Cl. CPC H01M 4/525; H01M 4/505; H01M 4/5825; H01M 2004/028

(57) ABSTRACT

Provided is a positive electrode using a spinel-type lithium-manganese-based composite oxide, which can impart, to a non-aqueous electrolyte secondary battery, excellent capacity deterioration resistance upon repeated charging and discharging. The positive electrode disclosed herein includes a positive electrode current collector and a positive electrode active material layer supported by the positive electrode current collector. The positive electrode active material layer includes a lithium-manganese-based composite oxide having a spinel-type crystal structure and including Mn, a lithium-nickel-based composite oxide including Li and Ni, and lithium phosphate.

### BACKGROUND OF THE INVENTION

### 1. Field of the Invention

The present disclosure relates to a positive electrode. The present disclosure also relates to a non-aqueous electrolyte secondary battery including the positive electrode. This application claims priority based on Japanese Patent Application No. 2021-041418 filed on Mar. 15, 2021, the entire contents of which are incorporated herein by reference.

### 2. Description of the Related Art

In recent years, non-aqueous electrolyte secondary batteries such as lithium ion secondary batteries have been suitably used for portable power sources for personal computers, mobile terminals, and the like, and for power supplies for driving vehicles such as battery electric vehicles (BEV), hybrid electric vehicles (HEV), plug-in hybrid electric vehicles (PHEV), and the like.

In a non-aqueous electrolyte secondary battery, an active material capable of occluding and releasing ions, which serve as charge carriers, is generally used. A lithium composite oxide is generally used as the active material for the positive electrode, and it is known that a composite oxide having a spinel-type crystal structure and containing manganese (that is, a spinel-type lithium-manganese-based composite oxide) can be used as the lithium composite oxide (see, for example, Japanese Patent Application Publication No. 2000-77071).

Spinel-type lithium-manganese-based composite oxides have the advantage of high thermal stability and low cost. However, as also indicated in Japanese Patent Application Publication No. 2000-77071, a problem of significant capacity deterioration occurring when a non-aqueous electrolyte secondary battery using a spinel-type lithium-manganese-based composite oxide is repeatedly charged and discharged has been well known for many years. To solve this problem, Japanese Patent Application Publication No. 2000-77071 proposes to use a spinel-type lithium-manganese-based composite oxide in combination with a lithium-nickel-based composite oxide.

### SUMMARY OF THE INVENTION

However, as a result of diligent studies by the present inventors, it was found that even with the technique described in Japanese Patent Application Publication No. 2000-77071, which is a conventional technique, the capacity deterioration occurring when a non-aqueous electrolyte secondary battery using a spinel-type lithium-manganese-based composite oxide is repeatedly charged and discharged still cannot be sufficiently suppressed.

Therefore, an object of the present disclosure is to provide a positive electrode using a spinel-type lithium-manganese-based composite oxide, the positive electrode being capable of imparting, to a non-aqueous electrolyte secondary battery, excellent capacity deterioration resistance upon repeated charging and discharging.

The positive electrode disclosed herein includes a positive electrode current collector and a positive electrode active material layer supported by the positive electrode current collector. The positive electrode active material layer includes a lithium-manganese-based composite oxide having a spinel-type crystal structure and including Mn, a lithium-nickel-based composite oxide including Li and Ni, and lithium phosphate. With such a configuration, it is possible to provide a positive electrode using a spinel-type lithium-manganese-based composite oxide, the positive electrode being capable of imparting, to a non-aqueous electrolyte secondary battery, excellent capacity deterioration resistance upon repeated charging and discharging.

In a desired mode of the positive electrode disclosed herein, a content ratio of the lithium-nickel-based composite oxide to a total of the lithium-manganese-based composite oxide, the lithium-nickel-based composite oxide, and the lithium phosphate is 5% by mass or more and 30% by mass or less. With such a configuration, higher capacity deterioration resistance can be imparted to the non-aqueous electrolyte secondary battery, and the initial resistance of the non-aqueous electrolyte secondary battery can be further reduced.

In a desired mode of the positive electrode disclosed herein, the lithium-nickel-based composite oxide further includes Al as an additive element. With such a configuration, the initial resistance of the non-aqueous electrolyte secondary battery becomes particularly small.

In this case, a molar ratio of Al to Ni (Al/Ni) is desirably 0.06 or more and 0.43 or less. With such a configuration, the initial resistance of the non-aqueous electrolyte secondary battery becomes particularly small, and the capacity deterioration resistance becomes particularly high.

In a desired mode of the positive electrode disclosed herein, a content ratio of the lithium phosphate to a total of the lithium-manganese-based composite oxide, the lithium-nickel-based composite oxide, and the lithium phosphate is 0.2% by mass or more and 10% by mass or less. With such a configuration, the capacity deterioration resistance of the non-aqueous electrolyte secondary battery becomes particularly high.

In a desired mode of the positive electrode disclosed herein, the lithium-manganese-based composite oxide has a composition represented by formula below. With such a configuration, the effect of suppressing capacity deterioration by the positive electrode disclosed herein becomes more prominent. Further, with such a configuration, it is possible to improve the thermal stability and reduce the cost of the non-aqueous electrolyte secondary battery.

Li₁₊ₐ(M3_{b}Mn_{2-a-b})O_{4-β}

(In the formula, M3 is at least one element selected from the group consisting of Al and Mg, a satisfies 0≤a≤0.20, b satisfies 0≤b≤0.20, and β satisfies 0≤β≤0.20.)

According to another aspect, the non-aqueous electrolyte secondary battery disclosed herein is a non-aqueous electrolyte secondary battery in which a battery assembly including the above-mentioned positive electrode, a negative electrode, and a non-aqueous electrolyte has been subjected to charging to 4.7 V or higher. With such a configuration, it is possible to provide a non-aqueous electrolyte secondary battery having excellent resistance to capacity deterioration upon repeated charging and discharging.

### BRIEF DESCRIPTION OF THE DRAWINGS

FIG. 1 is a cross-sectional view schematically showing a positive electrode according to an embodiment of the present disclosure;

FIG. 2 is a cross-sectional view schematically showing an internal structure of a lithium ion secondary battery using a positive electrode according to an embodiment of the present disclosure; and

FIG. 3 is a schematic exploded view showing the configuration of a wound electrode body of the lithium ion secondary battery shown in FIG. 2.

### DESCRIPTION OF THE PREFERRED EMBODIMENTS

Hereinafter, an embodiment according to the present disclosure will be described with reference to the drawings. Matters not mentioned in the present description and necessary for carrying out the present disclosure can be ascertained as design matters by a person skilled in the art based on the related art in the pertinent field. The present disclosure can be carried out based on the contents disclosed in the present description and general technical knowledge in the art. Further, in the following drawings, members/parts having the same action are represented by the same reference numerals for explanation. Further, the dimensional relations (length, width, thickness, and the like) in each drawing do not reflect the actual dimensional relations.

In the present description, the term “secondary battery” refers to a power storage device that can be charged and discharged repeatedly, and is a term inclusive of a so-called storage battery and a power storage element such as an electric double layer capacitor. Further, in the present specification, the “lithium ion secondary battery” refers to a secondary battery that uses lithium ions as charge carriers and realizes charge/discharge by the transfer of charges accompanying the lithium ions between the positive and negative electrodes.

Hereinafter, the present disclosure will be described in detail by taking a positive electrode to be used in a lithium ion secondary battery as an example, but the present disclosure is not intended to be limited to the positive electrode described in such an embodiment. FIG. 1 is a schematic cross-sectional view of the positive electrode according to the present embodiment, the view being perpendicular to the thickness direction.

As shown in the figure, a positive electrode 50 includes a positive electrode current collector 52 and a positive electrode active material layer 54 supported by the positive electrode current collector 52. The positive electrode active material layer 54 may be provided on one side of the positive electrode current collector 52, or may be provided on both sides of the positive electrode current collector 52 as shown in the figure. It is desirable that the positive electrode active material layer be provided on both sides of the positive electrode current collector 52.

As the positive electrode current collector 52, a known positive electrode current collector utilized in a lithium ion secondary battery may be used, and examples thereof include sheets or foils of metals having good conductivity (for example, aluminum, nickel, titanium, stainless steel, and the like). Aluminum foil is desirable as the positive electrode current collector 52.

The dimensions of the positive electrode current collector 52 are not particularly limited and may be appropriately determined according to the battery design. When an aluminum foil is used as the positive electrode current collector 52, the thickness thereof is not particularly limited, but is, for example, 5 μm or more and 35 μm or less, and desirably 7 μm or more and 20 μm or less.

In the present embodiment, the positive electrode active material layer 54 contains a lithium-manganese-based composite oxide having a spinel-type crystal structure and including Mn (spinel-type lithium-manganese-based composite oxide); a lithium-nickel-based composite oxide including Li and Ni; and lithium phosphate as essential components.

Therefore, in the present embodiment, a lithium-manganese-based composite oxide and a lithium-nickel-based composite oxide are used in combination as the positive electrode active material. In the present description, the “lithium-manganese-based composite oxide” refers to a composite oxide in which the molar amount of Mn among the molar amounts of all metal elements other than lithium contained in the composite oxide is the largest. Therefore, the “lithium-manganese-based composite oxide” may include one or more additive elements (for example, Ni, Co, Fe, Na, Mg, Al, P, K, Ca, Ba, Sr, Ti, V, Cr, Cu, Ga, Y, Zr, Nb, Mo, In, Ta, W, Re, Ce, and the like). Similarly, the “lithium-nickel-based composite oxide” refers to a composite oxide in which the molar amount of Ni among the molar amounts of all metal elements other than lithium contained in the composite oxide is the largest. Therefore, the “lithium-nickel-based composite oxide” may include one or more additive elements (for example, Mn, Co, Fe, Zn, Ti, Zr, Nb, W, P, Al, Mg, V, Ca, Sr, Cr, and the like).

Examples of spinel-type lithium-manganese-based composite oxides include lithium manganate (LiMn₂O₄) having a spinel-type crystal structure, and composite oxides having a spinel-type crystal structure in which a part of manganese of lithium manganate is replaced with lithium or other elements (for example, LiNi_{0.5}Mn_{1.5}O₄ and the like), and the like.

Specifically, as the spinel-type lithium-manganese-based composite oxide, for example, a composite oxide having a composition represented by the following formula (I) can be used.

Li_{1+z}(M1_{y}M2_{z}Mn_{2-x-y-z})o_{4-α} (I)

In formula (I), M1 is at least one element selected from the group consisting of Ni, Co, and Fe, and is desirably Ni. M2 is at least one element selected from a group consisting of Na, Mg, Al, P, K, Ca, Ba, Sr, Ti, V, Cr, Cu, Ga, Y, Zr, Nb, Mo, In, Ta, W, Re, and Ce, desirably Al and Mg.

In the formula (I), x satisfies 0≤x≤0.20, desirably 0≤x≤0.15. y satisfies 0≤y≤0.60, desirably 0≤y≤0.30, and more desirably is 0. z satisfies 0≤z≤0.5, desirably 0≤z≤0.10, and more desirably is 0. However, (2−x−y−z)>(y+z). α indicates oxygen deficiency or oxygen excess, and satisfies 0≤α≤0.20, desirably 0≤α≤0.05, and more desirably is 0.

Here, when the lithium-manganese-based composite oxide includes Al or Mg, the stability of the crystal structure under a high voltage becomes high. Therefore, the lithium-manganese-based composite oxide desirably further includes Al or Mg as an additive element.

Further, when the non-aqueous electrolyte secondary battery using LiMn₂O₄ is repeatedly charged and discharged, its capacity deterioration is particularly large. Therefore, in the present embodiment, the spinel-type lithium-manganese-based composite oxide is advantageously LiMn₂O₄ because the effect of suppressing capacity deterioration by the positive electrode according to the present embodiment becomes more prominent. Additional advantages of using LiMn₂O₄ are that high thermal stability can be imparted to the non-aqueous electrolyte secondary battery using the positive electrode 50, and the cost can be reduced.

Therefore, a particularly desirable composition of the lithium-manganese-based composite oxide is represented by the following formula (II).

Li₁₊ₐ(M3_{b}Mn_{2-a-b})O_{4-β} (II)

In formula (II), M3 is at least one element selected from the group consisting of Al and Mg, desirably Al.

In the formula (II), a satisfies 0≤a≤0.20, desirably 0.05≤a≤0.15; b satisfies 0≤b≤0.20, desirably 0≤b≤0.15; β indicates oxygen deficiency or excess and satisfies 0≤β≤0.20, desirably 0≤β≤0.05, and more desirably is 0.

In the present embodiment, the spinel-type lithium-manganese-based composite oxide having a certain composition may be used alone, or two or more kinds of spinel-type lithium-manganese-based composite oxides having different compositions may be used in combination.

Lithium-nickel-based composite oxides typically have a layered rock salt crystal structure, and examples thereof include lithium nickel oxide (LiNiO₂) having a layered rock salt crystal structure and a composite oxide having a layered rock salt crystal structure in which a part of nickel in lithium nickel oxide is replaced with lithium or another element (for example, LiNi_{0.8}Co_{0.15}Al_{0.05}O₂ and the like).

Specifically, for example, a composite oxide having a composition represented by the following formula (III) can be used as the lithium-nickel-based composite oxide.

Li₁₊ₛ(M4ₜM5ᵤNi₁₋ₜ₋ᵤ)O_{2-γ} (III)

In formula (III), M4 is at least one element selected from the group consisting of Mn and Co, and is desirably Co. M5 is at least one element selected from the group consisting of Fe, Zn, Ti, Zr, Nb, W, P, Al, Mg, V, Ca, Sr, and Cr, and is desirably Al.

In the formula (III), s satisfies −0.10≤s≤0.20, desirably 0≤s≤0.05, and more desirably is 0; t satisfies 0≤t≤0.50, desirably 0≤t≤0.20; u satisfies 0≤u≤0.5, desirably 0≤u≤0.30. However, (1−t−u)>(t+u); γ indicates oxygen deficiency or excess, and satisfies 0≤γ≤0.20, desirably 0≤γ≤0.05, and more desirably is 0.

Here, when a lithium-nickel-based composite oxide contains Al, the stability of the crystal structure under a high voltage is increased, and as a result, the initial resistance of the non-aqueous electrolyte secondary battery can be particularly reduced. Therefore, it is desirable that the lithium-nickel-based composite oxide further includes Al as an additive element.

The Al content is not particularly limited. The molar ratio of Al to Ni (Al/Ni) may be more than 0 and 0.67 or less (for example, 0.05 or more and 0.50 or less). The molar ratio of Al to Ni (Al/Ni) is desirably 0.06 or more and 0.43 or less because the initial resistance of the non-aqueous electrolyte secondary battery becomes particularly small and the capacity deterioration resistance becomes particularly high. From the viewpoint of higher capacity deterioration resistance, the molar ratio of Al to Ni (Al/Ni) is more desirably 0.06 or more and 0.25 or less.

A particularly desirable composition of the lithium-nickel-based composite oxide is represented by the following formula (IV).

Li₁₊ₚ(Ni_{1-q-r}Co_{q}Alᵣ)O_{2-δ} (IV)

In formula (IV), p satisfies −0.10≤p≤0.20, desirably 0≤p≤0.05, and more desirably is 0; q satisfies 0≤q≤0.20, desirably 0≤q≤0.15; r satisfies 0≤r≤0.4, desirably 0.05≤r≤0.15. However, (1−q−>(q+r). δ indicates oxygen deficiency or excess and satisfies 0≤δ≤0.20, desirably 0≤δ≤0.05, and more desirably is 0.

In the present embodiment, the lithium-nickel-based composite oxide having a certain composition may be used alone, or two or more kinds of lithium-nickel-based composite oxides having different compositions may be used in combination.

The positive electrode active material layer 54 may further contain a positive electrode active material other than the lithium-manganese-based composite oxide and the lithium-nickel-based composite oxide as long as the effects of the present disclosure are not significantly impaired.

The average particle size (median diameter D50) of the positive electrode active material is not particularly limited, but is, for example, 0.05 μm or more and 25 μm or less, desirably 0.5 μm or more and 23 μm or less, and more desirably 3 μm or more and 22 μm or less. The average particle size (median diameter D50) of the positive electrode active material can be determined by, for example, a laser diffraction/scattering method or the like.

The content of the positive electrode active material is not particularly limited, but is desirably 70% by mass or more, more desirably 80% by mass or more, and even more desirably 85% by mass or more in the positive electrode active material layer 54 (that is, with respect to the total mass of the positive electrode active material layer 54).

The positive electrode active material layer 54 includes lithium phosphate (Li₃PO₄) in addition to the above positive electrode active material. When a non-aqueous electrolyte secondary battery is manufactured by preparing a battery assembly (that is, a battery in a pre-shipment state) using a positive electrode provided with a positive electrode active material layer 54 including a combination of a spinel-type lithium-manganese-based composite oxide, a lithium-nickel-based composite oxide, and lithium phosphate, and initially charging the battery assembly to a predetermined voltage (in particular, 4.7 V or higher), the non-aqueous electrolyte secondary battery demonstrates excellent capacity deterioration resistance upon repeated charging and discharging.

This is considered to be due to the following reasons. By performing the initial charging to a predetermined voltage, a coating film derived from the lithium phosphate compound can be formed on the surface of the lithium-manganese-based composite oxide, and the elution of Mn can be suppressed by this coating film. The coating film formed by the initial charging to a voltage of 4.7 V or higher has a particularly high effect of suppressing Mn elution. However, Mn may elute before the coating film is formed (in particular, at a voltage of 4.7 V or higher, Mn tends to elute), but the elution of Mn before the coating film is formed can be suppressed by the lithium-nickel-based composite oxide. Specifically, the lithium-nickel-based composite oxide can capture an acid that causes Mn elution, and Mn of the lithium-manganese-based composite oxide can be prevented from being eluted into the electrolytic solution. Therefore, the elution of Mn can be suppressed to a higher degree than in the related art, and the capacity deterioration resistance upon repeated charging and discharging is remarkably improved.

In addition, the non-aqueous electrolyte secondary battery has a small initial resistance.

The ratios of lithium-manganese-based composite oxide, lithium-nickel-based composite oxide, and lithium phosphate are not particularly limited. The content ratio of the lithium-nickel-based composite oxide to the total of the lithium-manganese-based composite oxide, the lithium-nickel-based composite oxide, and lithium phosphate (that is, the essential three components) is, for example, 3% by mass or more and 40% by mass. From the viewpoint of a higher capacity deterioration suppression effect and a smaller initial resistance, the content ratio of the lithium-nickel-based composite oxide to the total of the above three essential components is desirably 5% by mass or more and 30% by mass or less, and more desirably 15% by mass or more and 30% by mass or less.

The higher the content of lithium phosphate contained in the positive electrode active material layer 54, the higher the capacity deterioration suppression effect tends to be. Therefore, the content ratio of lithium phosphate to the total of lithium-manganese-based composite oxide, lithium-nickel-based composite oxide, and lithium phosphate (that is, the essential three components) is desirably 0.1% by mass or more, more desirably 0.2% by mass or more, further desirably 0.5% by mass or more, and most desirably 1% by mass or more. Meanwhile, where the content of lithium phosphate becomes too large, the initial resistance becomes large and the capacity deterioration suppression effect becomes small. Therefore, the content ratio of lithium phosphate with respect to the total of the above essential three components is desirably 15% by mass or less, more desirably 12% by mass or less, and further desirably 10% by mass or less.

The positive electrode active material layer 54 may include components other than the positive electrode active material and lithium phosphate. Examples thereof include a conductive material and a binder.

As the conductive material, for example, carbon black such as acetylene black (AB) and other carbon materials (for example, graphite and the like) can be suitably used. The content of the conductive material in the positive electrode active material layer 54 is not particularly limited, but is, for example, 0.1% by mass or more and 20% by mass or less, desirably 1% by mass or more and 15% by mass or less, and more desirably 2% by mass or more and 10% by mass or less.

As the binder, for example, polyvinylidene fluoride (PVdF) or the like can be used. The content of the binder in the positive electrode active material layer 54 is not particularly limited, but is, for example, 0.5% by mass or more and 15% by mass or less, desirably 1% by mass or more and 10% by mass or less, and more desirably 1.5% by mass or more and 8% by mass or less.

The thickness of the positive electrode active material layer 54 is not particularly limited, but is, for example, 10 μm or more and 300 μm or less, and desirably 20 μm or more and 200 μm or less.

With the positive electrode 50 according to the present embodiment, it is possible to impart excellent capacity deterioration resistance to a non-aqueous electrolyte secondary battery upon repeated charging and discharging. In particular, when a non-aqueous electrolyte secondary battery is manufactured by preparing a battery assembly using the positive electrode 50 according to the present embodiment and initially charging the battery assembly to a predetermined voltage (in particular, 4.7 V or more), the non-aqueous electrolyte secondary battery has excellent capacity deterioration resistance upon repeated charging and discharging. The positive electrode 50 according to the present embodiment is typically for a secondary battery (in particular, for a non-aqueous electrolyte secondary battery), and is desirably used in a non-aqueous electrolyte secondary battery that is initially charged to a voltage of 4.7 V or more (in particular, 4.7 V or more and 5.0 V or less).

According to another aspect, the non-aqueous electrolyte secondary battery according to the present embodiment is a non-aqueous electrolyte secondary battery in which a battery assembly including the above-mentioned positive electrode, a negative electrode, and a non-aqueous electrolyte has been subjected to charging to 4.7 V or higher. In the present description, the “battery assembly” refers to a battery prior to shipping that has not been subjected to treatment for obtaining a commercial product, such as initial charging, aging processing, and conditioning processing.

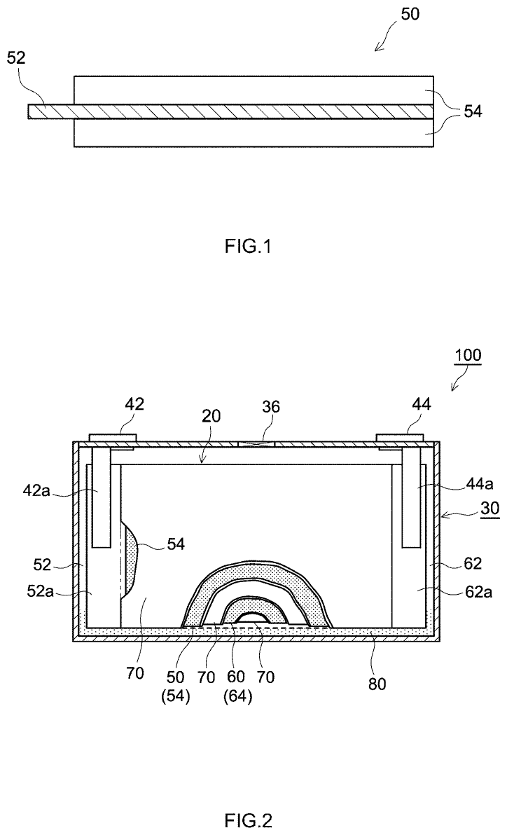

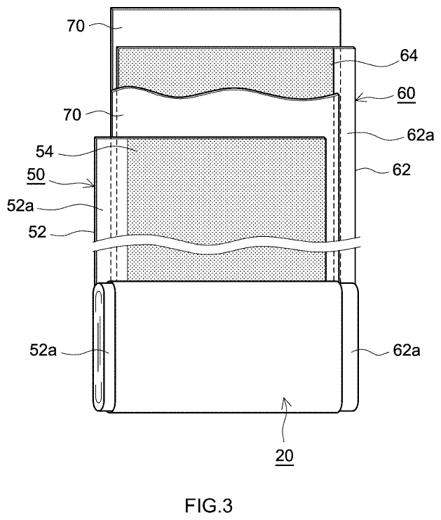

The non-aqueous electrolyte secondary battery according to the present embodiment will be specifically described below with reference to FIGS. 2 and 3 by taking the case of constructing a lithium ion secondary battery as an example. First, the battery assembly will be described.

A lithium ion secondary battery assembly 100 shown in FIG. 2 is an assembly of a sealed battery constructed by accommodating a flat wound electrode body 20 and a non-aqueous electrolyte 80 in a flat angular battery case (that is, an outer container) 30. The battery case 30 is provided with a positive electrode terminal 42 and a negative electrode terminal 44 for external connection, and a thin-walled safety valve 36 set to release the internal pressure when the internal pressure of the battery case 30 rises to equal to or above a predetermined level. Further, the battery case 30 is provided with an injection port (not shown) for injecting the non-aqueous electrolyte 80. The positive electrode terminal 42 is electrically connected to a positive electrode current collector plate 42a. The negative electrode terminal 44 is electrically connected to a negative electrode current collector plate 44a. As the material of the battery case 30, for example, a lightweight metal material having good thermal conductivity such as aluminum is used. It should be noted that FIG. 2 does not accurately represent the amount of the non-aqueous electrolyte 80.

As shown in FIGS. 2 and 3, the wound electrode body 20 has a form in which a positive electrode sheet 50 and a negative electrode sheet 60 are overlapped with each other with two long separator sheets 70 interposed therebetween and wound in the longitudinal direction. The positive electrode sheet 50 has a configuration in which a positive electrode active material layer 54 is formed along the longitudinal direction on one side or both sides (here, both sides) of a long positive electrode current collector 52. The negative electrode sheet 60 has a configuration in which a negative electrode active material layer 64 is formed along the longitudinal direction on one side or both sides (here, both sides) of a long negative electrode current collector 62. A positive electrode active material layer non-formation portion 52a (that is, the portion where the positive electrode active material layer 54 is not formed and the positive electrode current collector 52 is exposed) and a negative electrode active material layer non-formation portion 62a (that is, the portion where the negative electrode active material layer 64 is not formed and the negative electrode current collector 62 is exposed) are formed so as to protrude outward from both ends of the wound electrode body 20 in the winding axis direction (that is, in the sheet width direction orthogonal to the longitudinal direction). A positive electrode current collector plate 42a and a negative electrode current collector plate 44a are joined to the positive electrode active material layer non-formation portion 52a and the negative electrode active material layer non-formation portion 62a, respectively.

As the positive electrode sheet 50, the positive electrode 50 according to the present embodiment described above is used. In this configuration example, the positive electrode sheet 50 has the positive electrode active material layers 54 formed on both sides of the positive electrode current collector 52.

As the negative electrode current collector 62 constituting the negative electrode sheet 60, a known negative electrode current collector utilized in a lithium ion secondary battery may be used, and examples thereof include sheets or foils made of metals having good conductivity (for example, copper, nickel, titanium, stainless steel, and the like). Copper foil is desirable as the negative electrode current collector 62.

The dimensions of the negative electrode current collector 62 are not particularly limited and may be determined, as appropriate, according to the battery design. When a copper foil is used as the negative electrode current collector 62, the thickness of the copper foil is not particularly limited, but is, for example, 5 μm or more and 35 μm or less, and desirably 7 μm or more and 20 μm or less.

The negative electrode active material layer 64 contains a negative electrode active material. As the negative electrode active material, for example, a carbon material such as graphite, hard carbon, soft carbon, or the like can be used. The graphite may be natural graphite or artificial graphite, or may be amorphous carbon-coated graphite in which graphite is coated with an amorphous carbon material.

The average particle size (median diameter D50) of the negative electrode active material is not particularly limited, but is, for example, 0.1 μm or more and 50 μm or less, desirably 1 μm or more and 25 μm or less, and more desirably 5 μm or more and 20 μm or less.

The content of the negative electrode active material in the negative electrode active material layer is not particularly limited, but is desirably 90% by mass or more, and more desirably 95% by mass or more.

The negative electrode active material layer 64 may contain components other than the negative electrode active material, such as a binder, a thickener, or the like.

As the binder, for example, styrene butadiene rubber (SBR) and modified products thereof, acrylonitrile butadiene rubber and modified products thereof, acrylic rubber and modified products thereof, fluororubber, and the like can be used. Of these, SBR is desirable. The content of the binder in the negative electrode active material layer 64 is not particularly limited, but is desirably 0.1% by mass or more and 8% by mass or less, and more desirably 0.2% by mass or more and 3% by mass or less.

As the thickener, for example, a cellulosic polymer such as carboxymethyl cellulose (CMC), methyl cellulose (MC), cellulose acetate phthalate (CAP), hydroxypropyl methyl cellulose (HPMC); polyvinyl alcohol (PVA), or the like can be used. Of these, CMC is desirable. The content of the thickener in the negative electrode active material layer 64 is not particularly limited, but is desirably 0.3% by mass or more and 3% by mass or less, and more desirably 0.4% by mass or more and 2% by mass or less.

The thickness of the negative electrode active material layer 64 is not particularly limited, but is, for example, 10 μm or more and 300 μm or less, and desirably 20 μm or more and 200 μm or less.

Examples of the separator 70 include a porous sheet (film) made of a resin such as polyethylene (PE), polypropylene (PP), a polyester, cellulose, and a polyamide. Such a porous sheet may have a single-layer structure or a laminated structure of two or more layers (for example, a three-layer structure in which PP layers are laminated on both sides of a PE layer). A heat-resistant layer (HRL) may be provided on the surface of the separator 70.

The thickness of the separator 70 is not particularly limited, but is, for example, 5 μm or more and 50 μm or less, and desirably 10 μm or more and 30 μm or less.

The non-aqueous electrolyte 80 typically includes a non-aqueous solvent and an electrolyte salt (in other words, a supporting salt). As the non-aqueous solvent, various organic solvents such as carbonates, ethers, esters, nitriles, sulfones, and lactones used in the electrolytic solution of a general lithium ion secondary battery can be used without particular limitation. Of these, carbonates are desirable, and specific examples thereof include ethylene carbonate (EC), propylene carbonate (PC), diethyl carbonate (DEC), dimethyl carbonate (DMC), ethyl methyl carbonate (EMC), and monofluoroethylene carbonate (MFEC), difluoroethylene carbonate (DFEC), monofluoromethyldifluoromethyl carbonate (F-DMC), trifluorodimethyl carbonate (TFDMC), and the like. As such a non-aqueous solvent, one type can be used alone, or two or more types can be used in combination as appropriate.

As the electrolyte salt, for example, lithium salts such as LiPF₆, LiBF₄, and lithium bis (fluorosulfonyl) imide (LiFSI) can be used, and particularly, LiPF₆ is desirable. The concentration of the electrolyte salt is not particularly limited, but is desirably 0.7 mol/L or more and 1.3 mol/L or less.

The non-aqueous electrolyte 80 may include components other than the above-mentioned components, for example, various additives such as a film-forming agent such as an oxalate complex or the like, a gas-generating agent such as biphenyl (BP), cyclohexylbenzene (CHB), and the like, a thickener, and the like as long as the effects of the present disclosure are not significantly impaired.

The lithium ion secondary battery in this example is the one in which the battery assembly has been initially charged to a voltage of 4.7 V or more (desirably 4.7 V or more and 5.0 V or less).

By this initial charging, a coating film is formed on the surface of the particles of the lithium-manganese-based composite oxide contained in the positive electrode active material layer 54. By initial charging to a high voltage of 4.7 V or more, a LiMnPO₄ component is generated in the coating film.

Therefore, the lithium ion secondary battery has a feature that a coating film is provided on the surface of the particles of the lithium-manganese-based composite oxide, and the coating film contains a P component including a LiMnPO₄ component and an F component. The coating film may further include a P component other than LiMnPO₄. Further, when the particles of the lithium-manganese-based composite oxide are cracked, the coating film is present on the particle surface including the cracked portion of the particles of the lithium-manganese-based composite oxide.

The fact that the coating film includes a P component and an F component can be confirmed, for example, by analysis by energy dispersive X-ray spectroscopy (TEM-EDX) using a transmission electron microscope (TEM).

For example, the fact that the coating film includes the LiMnPO₄ component can be confirmed in the following manner. LiMnPO₄ has an olivine crystal structure. Therefore, a lattice image of a high-angle annular dark-field image (HAAD image) is acquired using a TEM, and the crystal structure is analyzed to confirm that the crystal structure is an olivine type. Further, the coating film is analyzed by electron energy loss spectroscopy (TEM-EELS) using TEM to confirm the presence of Li, the presence of divalent Mn, and the presence of P.

The LiMnPO₄ component in the coating film is derived from lithium phosphate. Therefore, at least a part of lithium phosphate is consumed by the initial charging. Therefore, in the lithium ion secondary battery, the content ratio of lithium phosphate with respect to the total of the lithium-manganese-based composite oxide, the lithium-nickel-based composite oxide, and the lithium phosphate (that is, the essential three components) in the positive electrode active material layer 54 can be less than 15% by mass, less than 10% by mass, less than 5% by mass, less than 3% by mass, or less than 1% by mass.

In the lithium-ion secondary battery configured as described above, the capacity is less likely to deteriorate upon repeated charging and discharging. That is, the lithium ion secondary battery has excellent cycle characteristics. In addition, the lithium ion secondary battery has a small initial resistance.

According to another aspect, disclosed herein is a method for manufacturing a non-aqueous electrolyte secondary battery including a step of preparing a battery assembly including the above-mentioned positive electrode, negative electrode, and non-aqueous electrolyte, and a step of performing an initial charging process of the battery assembly until a voltage reaches 4.7 V or more (particularly 4.7 V or more and 5.0 V or less). Each step can be carried out according to a known method. In the positive electrode used in the step of preparing the battery assembly, the particles of the lithium-manganese-based composite oxide may be cracked due to the pressing treatment of the positive electrode active material layer or the like.

Lithium ion secondary batteries can be used for various purposes. Suitable applications include drive power supplies mounted on vehicles such as battery electric vehicles (BEVs), hybrid electric vehicles (HEVs), and plug-in hybrid electric vehicles (PHEVs). Further, the lithium ion secondary battery 100 can be used as a storage battery for a small power storage device or the like. The lithium ion secondary battery 100 may also be used in the form of a battery pack which typically consists of a plurality of batteries connected in series and/or in parallel.

As an example, the angular lithium ion secondary battery 100 provided with the flat wound electrode body 20 has been described. However, the non-aqueous electrolyte secondary battery disclosed herein can also be configured as a lithium ion secondary battery including a stacked-type electrode body (that is, an electrode body in which a plurality of positive electrodes and a plurality of negative electrodes are alternately laminated). Further, the non-aqueous electrolyte secondary battery disclosed herein can also be configured as a cylindrical lithium ion secondary battery, a laminate-cased lithium ion secondary battery, a coin type lithium ion secondary battery, or the like. Further, the non-aqueous electrolyte secondary battery disclosed herein can also be configured as a non-aqueous electrolyte secondary battery other than the lithium ion secondary battery according to a known method.

Hereinafter, examples relating to the present disclosure will be described, but the present disclosure is not intended to be limited to the configurations shown in such examples.

Test A—Study of Combination of Lithium-Manganese-Based Composite Oxide, Lithium-Nickel-Based Composite Oxide and Lithium Phosphate

### Preparation of Lithium Ion Secondary Battery for Evaluation of Each Test Example

Li_{1.1}Al_{0.1}Mn_{1.8}O₄ (LMO) as a lithium-manganese-based composite oxide, LiNi_{0.8}Co_{0.15}Al_{0.05}O₂ as a lithium-nickel-based composite oxide, and Li₃PO₄ were mixed to obtain the mass ratios thereof shown in Table 1. This mixture was mixed in N-methyl-2-pyrrolidone (NMP) with carbon black (CB) as a conductive material and polyvinylidene fluoride (PVdF) as a binder at mass ratios of positive electrode active material:CB:PVdF=90:8:2 to prepare a slurry for forming a positive electrode active material layer.

This slurry for forming a positive electrode active material layer was applied onto an aluminum foil, dried, and then subjected to a densification treatment by a roll press to prepare a positive electrode sheet. This positive electrode sheet was cut to a size of 120 mm×100 mm.

Further, spheroidized graphite (C) as a negative electrode active material, styrene butadiene rubber (SBR) as a binder, and carboxymethyl cellulose (CMC) as a thickener were mixed in ion-exchanged water at mass ratios of C:SBR:CMC=98:1:1 to prepare a slurry for forming a negative electrode active material layer. This slurry for forming a negative electrode active material layer was applied onto a copper foil, dried, and then subjected to a densification treatment by a roll press to prepare a negative electrode sheet. This negative electrode sheet was cut to a size of 122 mm×102 mm.

A porous polyolefin sheet was prepared as a separator sheet. A stacked-type electrode body was produced by sandwiching the separator between the positive electrode sheet and the negative electrode sheet, and electrode terminals were attached to the laminated electrode body. This was accommodated together with a non-aqueous electrolytic solution in a laminate case. The non-aqueous electrolytic solution used was prepared by dissolving LiPF₆ at a concentration of 1.1 mol/L in a mixed solvent containing ethylene carbonate (EC), dimethyl carbonate (DMC) and ethyl methyl carbonate (EMC) in volume ratios of 3:3:4. Next, the laminate case was sealed to prepare a battery assembly.

As an initial charging process, the battery assembly was constant-current charged at a current value of 0.1 C to the voltage shown in Table 1, and then constant-voltage charged until the current value became 1/50C, thereby implementing the initial charging. Then, constant-current discharging was performed to 3.0 V at a current value of 0.1 C to obtain lithium ion secondary batteries for evaluation of each test example (each Example, each Comparative Example and Reference Example 1).

Evaluation of Cycle Characteristic

Each lithium ion secondary battery for evaluation produced above was placed in an environment of 25° C. Each lithium ion secondary battery for evaluation was constant-current charged at 0.1 C to 4.2 V, and then constant-voltage charged until the current value became 1/50C, resulting in a fully charged state. Then, each lithium ion secondary battery for evaluation was constant-current discharged to 3.0 V at a current value of 0.1 C. This charging/discharging was performed for 3 cycles, the discharge capacity at the time of the third discharge was measured, and this was used as the initial capacity.

Next, each lithium ion secondary battery for evaluation was placed in an environment of 60° C., and charging/discharging including constant-current charging to 4.2 V at 1 C and constant-current discharging to 3.0 V at 1 C as one cycle was repeated for 50 cycles. The discharge capacity after 50 cycles was determined by the same method as the initial capacity. As an index of cycle characteristic (capacity deterioration resistance), the capacity retention rate (%) was determined from [(discharge capacity after 50 cycles of charging/discharging)/(initial capacity)]×100. The capacity retention rate of the lithium ion secondary battery for evaluation of Comparative Example 1 was taken as 1.00, and the ratio of the capacity retention rate of other lithium ion secondary batteries for evaluation to the lithium ion secondary battery for evaluation of Comparative Example 1 was obtained. The results are shown in Table 1.

Evaluation of Initial Resistance

After adjusting each of the prepared lithium ion secondary batteries for evaluation to a state of SOC 50%, the batteries were placed in an environment of 25° C. Discharging was performed for 2 sec at various current values, and the battery voltage after discharging at each current value was measured. An I-V characteristic at the time of discharge was obtained by plotting each current value and each battery voltage, and the IV resistance (Ω) at the time of discharge was obtained as the initial resistance from the slope of the obtained straight line. The initial resistance of the lithium ion secondary battery for evaluation of Comparative Example 1 was taken as 1.00, and the ratio of the initial resistance of other lithium secondary batteries for evaluation to the lithium ion secondary battery for evaluation of Comparative Example 1 was obtained. The results are shown in Table 1.

Evaluation of Mn Precipitation Amount on Negative Electrode

Each lithium ion secondary battery for evaluation produced by performing the above initial charge was disassembled and punched near the center of the negative electrode by using a 22 mm square punching punch, and the weight thereof was measured. Subsequently, the negative electrode active material layer was peeled off from the punched negative electrode, and graphite was collected. The required amount of graphite was weighed to prepare a sample, which was transferred to a beaker, an acid was added, and heat decomposition was performed. The residue was filtered off, subjected to ashing, melted with an alkaline melt, and then acid-extracted. This was combined with the filtrate and transferred to a volumetric flask, and the volume was adjusted to prepare a measurement solution. ICP mass spectrometry was performed on this measurement solution using an ICP-MS apparatus “7700X” manufactured by Agilent Technologies, and the Mn precipitation amount on the negative electrode was determined based on the analysis result. The Mn precipitation amount on the negative electrode of the lithium ion secondary battery for evaluation of Comparative Example 1 was taken as 1.00, and the ratio of Mn precipitation amount on the negative electrode of other lithium ion secondary batteries for evaluation to that in the lithium ion secondary battery for evaluation of Comparative Example 1 was obtained. The results are shown in Table 1.

TABLE 1

| | | | | | Ratio of Mn | | |
|---|---|---|---|---|---|---|---|
| | Positive electrode active | | | Initial | precipitation | Initial | Capacity |
| | material layer components | | | charging | amount on negative | resistance | retention |
| | LMO | LiNi_{0.8}Co_{0.15}Al_{0.05}O₂ | Li₃PO₄ | voltage (V) | electrode | ratio | rate ratio |
| Comparative | 100 | 0 | 0 | 4.2 | 1.00 | 1.00 | 1.00 |
| example 1 | | | | | | | |
| Comparative | 100 | 0 | 0 | 4.7 | 1.42 | 1.47 | 0.77 |
| example 2 | | | | | | | |
| Comparative | 99.5 | 0 | 0.5 | 4.2 | 0.94 | 0.96 | 1.05 |
| example 3 | | | | | | | |
| Comparative | 95 | 5 | 0 | 4.2 | 0.86 | 0.86 | 1.10 |
| example 4 | | | | | | | |
| Comparative | 85 | 15 | 0 | 4.2 | 0.51 | 0.83 | 1.18 |
| example 5 | | | | | | | |
| Comparative | 75 | 25 | 0 | 4.2 | 0.26 | 0.79 | 1.27 |
| example 6 | | | | | | | |
| Reference | 94.5 | 5 | 0.5 | 4.2 | 0.84 | 0.85 | 1.07 |
| example 1 | | | | | | | |
| Example 1 | 94.5 | 5 | 0.5 | 4.7 | 0.77 | 0.93 | 1.37 |
| Example 2 | 89.5 | 10 | 0.5 | 4.7 | 0.66 | 0.90 | 1.40 |
| Example 3 | 84.5 | 15 | 0.5 | 4.7 | 0.47 | 0.88 | 1.42 |
| Example 4 | 79.5 | 20 | 0.5 | 4.7 | 0.35 | 0.86 | 1.45 |
| Example 5 | 74.5 | 25 | 0.5 | 4.7 | 0.22 | 0.79 | 1.48 |
| Example 6 | 69.5 | 30 | 0.5 | 4.7 | 0.19 | 0.83 | 1.42 |

Comparing Comparative Example 1 and Comparative Example 3, it can be seen that the capacity retention rate is slightly increased by adding lithium phosphate to the lithium-manganese-based composite oxide. Further, by comparing Comparative Example 1 and Comparative Examples 4 to 6, it can be seen that the capacity retention rate is improved by adding the lithium-nickel-based composite oxide to the lithium-manganese-based composite oxide.

Meanwhile, by comparing these Comparative Examples with Examples 1 to 6, it can be seen that the capacity retention rate is remarkably improved by combining the lithium-manganese-based composite oxide with the lithium-nickel-based composite oxide and lithium phosphate. This improvement effect was much larger than the sum of the improvement effect exerted by the lithium phosphate, which was ascertained by comparing Comparative Example 1 and Comparative Example 3, and the improvement effect exerted by the lithium-nickel-based composite oxide, which was ascertained by comparing Comparative Example 1 and Comparative Examples 4 to 6.

Further, regarding the initial charging voltage, different tendencies were observed between Comparative Example 1 and Comparative Example 2, and between Example 1 and Reference Example 1. From the above, it is clear that when a lithium-manganese-based composite oxide, a lithium-nickel-based composite oxide, and lithium phosphate are used in combination in a positive electrode active material layer and the initial charging is performed at a predetermined voltage, a remarkably high capacity deterioration suppression effect can be obtained by the synergistic effect. That is, according to the positive electrode disclosed here, it can be seen that the non-aqueous electrolyte secondary battery can be provided with excellent capacity deterioration resistance upon repeated charging and discharging.

Test B—Study of Initial Charging Voltage of Battery Using Positive Electrode

Li_{1.1}Al_{0.1}Mn_{1.8}O₄ (LMO) as a lithium-manganese-based composite oxide, LiNi_{0.8}Co_{0.15}Al_{0.05}O₂ as a lithium-nickel-based composite oxide, and Li₃PO₄ as lithium phosphate were mixed at mass ratios of 94.5:5:0.5, and the mixture was used to prepare a battery assembly in the same manner as in Test A.

As the initial charging process, the battery assembly was constant-current charged at a current value of 0.1 C to the voltage shown in Table 2, and then constant-voltage charged for 3 h, thereby implementing the initial charging. Then, constant-current discharging was performed to 3.0 V at a current value of 0.1 C to obtain lithium ion secondary batteries for evaluation of each test example (each Example and Reference Example 2).

The Mn precipitation amount on the negative electrode, initial resistance, and capacity retention rate were evaluated for the lithium ion secondary batteries for evaluation of each test example in the same manner as in Test A. For each of these values, the ratio to the value of Comparative Example 1 of Test A was obtained by taking the value of Comparative Example 1 of Test A as 1.00. The results are shown in Table 2 together with the results of Example 1 and Reference Example 1.

TABLE 2

| | | | | | Ratio of Mn | | |
|---|---|---|---|---|---|---|---|
| | Positive electrode active | | | Initial | precipitation | Initial | Capacity |
| | material layer components | | | charging | amount on negative | resistance | retention |
| | LMO | LiNi_{0.8}Co_{0.15}Al_{0.05}O₂ | Li₃PO₄ | voltage (V) | electrode | ratio | rate ratio |
| Reference | 94.5 | 5 | 0.5 | 4.2 | 0.84 | 0.85 | 1.07 |
| example 1 | | | | | | | |
| Reference | 94.5 | 5 | 0.5 | 4.6 | 0.81 | 0.89 | 1.18 |
| example 2 | | | | | | | |
| Example 1 | 94.5 | 5 | 0.5 | 4.7 | 0.77 | 0.93 | 1.37 |
| Example 7 | 94.5 | 5 | 0.5 | 4.8 | 0.84 | 0.96 | 1.40 |
| Example 8 | 94.5 | 5 | 0.5 | 4.9 | 0.83 | 0.98 | 1.43 |
| Example 9 | 94.5 | 5 | 0.5 | 5.0 | 0.83 | 0.99 | 1.47 |

As shown by the results in Table 2, it can be seen that the capacity retention rate becomes particularly high when the initial charge voltage is 4.7 V or higher. The present inventors additionally examined the coating film formed on the positive electrode, analyzed the crystal structure by TEM-HAAD, and performed analysis by TEM-EELS. It was thereby confirmed that when the initial charge voltage was 4.7 V or more, the LiMnPO₄ component was contained in the coating film. Meanwhile, when the initial charge voltage was 4.6 V or less, the LiMnPO₄ component was not contained in the coating film. Therefore, it is understood that by setting the initial charge voltage to 4.7 V or higher, a coating film including a new component (that is, the LiMnPO₄ component) is formed on the positive electrode, and the coating film exhibits a particularly high capacity deterioration suppression effect.

Test C—Examination of the Type of Lithium-Nickel-Based Composite Oxide

Li_{1.1}Al_{0.1}Mn_{1.8}O₄(LMO) as a lithium-manganese-based composite oxide, the composite oxides shown in Table 3 as a lithium-nickel-based composite oxide, and Li₃PO₄ as lithium phosphate were mixed at a mass ratio of 74.5:25:0.5, and the mixtures were used to prepare battery assemblies in the same manner as in Test A.

As the initial charging process, the battery assemblies were constant-current charged to 4.7 V at a current value of 0.1 C, and then constant-voltage charged for 3 h, thereby implementing the initial charging. Then, constant-current discharging was performed to 3.0 V at a current value of 0.1 C to obtain lithium ion secondary batteries for evaluation of each Example.

The Mn precipitation amount on the negative electrode, initial resistance, and capacity retention rate were evaluated for the lithium ion secondary batteries for evaluation of each Example in the same manner as in Test A. For each of these values, the ratio to the value of Comparative Example 1 of Test A was obtained by taking the value of Comparative Example 1 of Test A as 1.00. The results are shown in Table 3 together with the results of Example 5.

TABLE 3

| | | | | Ratio of Mn | | |
|---|---|---|---|---|---|---|
| | | Al/Ni | Initial | precipitation | Initial | Capacity |
| | Lithium-nickel-based | molar | charging | amount on negative | resistance | retention |
| | composite oxide type | ratio | voltage (V) | electrode | ratio | rate ratio |
| Example 5 | LiNi_{0.8}Co_{0.15}Al_{0.05}O₂ | 0.06 | 4.7 | 0.22 | 0.79 | 1.48 |
| Example 10 | LiNiO₂ | 0.00 | 4.7 | 0.19 | 0.84 | 1.22 |
| Example 11 | LiNi_{0.8}Co_{0.2}O₂ | 0.00 | 4.7 | 0.23 | 0.82 | 1.25 |
| Example 12 | LiNi_{0.9}Al_{0.1}O₂ | 0.11 | 4.7 | 0.2 | 0.77 | 1.50 |
| Example 13 | LiNi_{0.8}Al_{0.2}O₂ | 0.25 | 4.7 | 0.18 | 0.75 | 1.49 |
| Example 14 | LiNi_{0.7}Al_{0.3}O₂ | 0.43 | 4.7 | 0.22 | 0.72 | 1.40 |
| Example 15 | LiNi_{0.81}Co_{0.10}Al_{0.09}O₂ | 0.11 | 4.7 | 0.21 | 0.76 | 1.51 |
| Example 16 | LiNi_{0.97}Al_{0.03}O₂ | 0.03 | 4.7 | 0.17 | 0.8 | 1.27 |
| Example 17 | LiNi_{0.6}Al_{0.4}O₂ | 0.67 | 4.7 | 0.26 | 0.71 | 1.22 |

As shown by the results in Table 3, it can be seen that the initial resistance becomes smaller when Al is added to the lithium-nickel-based composite oxide. This is conceivably because the addition of Al increases the structural stability of the lithium-nickel-based composite oxide under a high voltage, and even when the initial charge is performed to a high voltage of 4.7 V, the crystal structure is unlikely to collapse. Meanwhile, it was observed that when the amount of Al added was considerably large, the effect of improving the capacity retention rate tended to decrease. This is conceivably because the amount of Ni that exerts the effect of improving the capacity retention rate decreases as the amount of Al increases. It is clear that when the molar ratio of Al to Ni (Al/Ni) is in a specific range (that is, 0.06 or more and 0.43 or less), a high initial resistance reducing effect and a high capacity deterioration suppression effect can be obtained.

Test D—Examination of Blended Amount of Lithium Phosphate

Li_{1.1}Al_{0.1}Mn_{1.8}O₄ (LMO) as a lithium-manganese-based composite oxide, LiNi_{0.8}Co_{0.15}Al_{0.05}O₂ as a lithium-nickel-based composite oxide, and Li₃PO₄ as lithium phosphate were mixed so that the ratios thereof had the values shown in Table 4, and the mixtures were used to prepare battery assemblies in the same manner as in Test A.

As the initial charging process, the battery assemblies were constant-current charged to 4.7 V at a current value of 0.1 C, and then constant-voltage charged for 3 h, thereby implementing the initial charging. Then, constant-current discharging was performed to 3.0 V at a current value of 0.1 C to obtain lithium ion secondary batteries for evaluation of each Example and each Comparative Example.

The Mn precipitation amount on the negative electrode, initial resistance, and capacity retention rate were evaluated for the lithium ion secondary batteries for evaluation of each Example in the same manner as in Test A. For each of these values, the ratio to the value of Comparative Example 1 of Test A was obtained by taking the value of Comparative Example 1 of Test A as 1.00. The results are shown in Table 4 together with the results of Example 1 and Comparative Example 4.

TABLE 4

| | | | | | Ratio of Mn | | |
|---|---|---|---|---|---|---|---|
| | Positive electrode active | | | Initial | precipitation | Initial | Capacity |
| | material layer components | | | charging | amount on negative | resistance | retention |
| | LMO | LiNi_{0.8}Co_{0.15}Al_{0.05}O₂ | Li₃PO₄ | voltage (V) | electrode | ratio | rate ratio |
| Comparative | 95.0 | 5 | 0.0 | 4.2 | 0.86 | 0.86 | 1.10 |
| example 4 | | | | | | | |
| Example 1 | 94.5 | 5 | 0.5 | 4.7 | 0.77 | 0.93 | 1.37 |
| Example 18 | 94.9 | 5 | 0.1 | 4.7 | 0.85 | 1.10 | 1.13 |
| Example 19 | 94.8 | 5 | 0.2 | 4.7 | 0.83 | 0.97 | 1.26 |
| Example 20 | 94.7 | 5 | 0.3 | 4.7 | 0.79 | 0.96 | 1.27 |
| Example 21 | 94.0 | 5 | 1.0 | 4.7 | 0.75 | 0.95 | 1.33 |
| Example 22 | 90.0 | 5 | 5.0 | 4.7 | 0.71 | 0.97 | 1.44 |
| Example 23 | 85.0 | 5 | 10.0 | 4.7 | 0.67 | 0.99 | 1.46 |
| Example 24 | 80.0 | 5 | 15.0 | 4.7 | 0.61 | 1.13 | 1.26 |

As shown by the results in Table 4, increasing the content ratio of lithium phosphate tended to increase the capacity retention rate. In particular, when the content ratio of lithium phosphate in the three components shown in the table was 0.2% by mass or more, the capacity retention rate was remarkably increased. This is conceivably because the amount of the coating film derived from lithium phosphate has reached an amount capable of exerting a remarkably high effect of improving the capacity retention rate. Meanwhile, when the content ratio was increased to 15% by mass, the effect of improving the capacity retention rate decreased. This is conceivably because as the content of lithium phosphate increases, the thickness of the coating film increases, and because lithium phosphate is a resistance component, and thus the initial resistance increases, which causes the reaction in the positive electrode active material layer to be non-uniform and increases the amount of Mn eluted locally. Therefore, when the content ratio of lithium phosphate in the three components shown in the table is 0.2% by mass or more and 10% by mass or less (particularly 0.5% by mass or more and 10% by mass or less), a particularly high capacity deterioration suppression effect can be obtained.

Although specific examples of the present disclosure have been described in detail above, these are merely examples and do not limit the scope of claims. The techniques described in the claims are inclusive of various changes and modifications of the specific examples illustrated above.

What is claimed is:

1. A positive electrode comprising a positive electrode current collector and a positive electrode active material layer supported by the positive electrode current collector, wherein
the positive electrode active material layer includes a lithium-manganese-based composite oxide having a spinel-type crystal structure and including Mn, a lithium-nickel-based composite oxide including Li and Ni, and lithium phosphate.

2. The positive electrode according to claim 1, wherein a content ratio of the lithium-nickel-based composite oxide to a total of the lithium-manganese-based composite oxide, the lithium-nickel-based composite oxide, and the lithium phosphate is 5% by mass or more and 30% by mass or less.

3. The positive electrode according to claim 1, wherein the lithium-nickel-based composite oxide further includes Al as an additive element.

4. The positive electrode according to claim 3, wherein a molar ratio of Al to Ni (Al/Ni) is 0.06 or more and 0.43 or less.

5. The positive electrode according to claim 1, wherein a content ratio of the lithium phosphate to a total of the lithium-manganese-based composite oxide, the lithium-nickel-based composite oxide, and the lithium phosphate is 0.2% by mass or more and 10% by mass or less.

6. The positive electrode according to claim 1, wherein the lithium-manganese-based composite oxide has a composition represented by the following formula:
Li₁₊ₐ(M3_{b}Mn_{2-a-b})O_{4-β}
wherein M3 is at least one element selected from the group consisting of Al and Mg, a satisfies 0≤a≤0.20, b satisfies 0≤b≤0.20, and β satisfies 0≤β≤0.20.

7. A non-aqueous electrolyte secondary battery, wherein a battery assembly including the positive electrode according to claim 1, a negative electrode, and a non-aqueous electrolyte has been subjected to charging to 4.7 V or higher.
